(19) United States
(12) Patent Application Publication
(10) Pub. No.: US 2023/0391305 A1
(43) Pub. Date: Dec. 7, 2023

(54) ELECTRONIC BRAKE SYSTEM

(71) Applicant: HL MANDO CORPORATION, Gyeonggi-do (KR)

(72) Inventors: Jinseok KIM, Gyeonggi-do (KR); Seongho CHOI, Gyeonggi-do (KR)

(21) Appl. No.: 18/034,676

(22) PCT Filed: Nov. 1, 2021
(86) PCT No.: PCT/KR2021/015554

§ 371 Date: Apr. 29, 2023

(30) Foreign Application Priority Data
Oct. 30, 2020 (KR) 10-2020-0143754
Oct. 29, 2021 (KR) 10-2021-0147166

(51) Int. Cl. B60T 13/74; B60T 8/40

(52) U.S. Cl. CPC B60T 13/745; B60T 8/4081; B60T 7/042

(57) ABSTRACT

An electronic brake system is disclosed. The electronic brake system, according to the present embodiment, comprises: a pedal unit that is connected to a brake pedal and operated by a driver's pedal effort; and a hydraulic pressure providing unit that generates hydraulic pressure of a pressurizing medium for braking a vehicle on the basis of an electrical signal outputted in response to displacement of the brake pedal, wherein the pedal unit and the hydraulic pressure providing unit may be disposed to be physically separated from each other on a vehicle body.

### CROSS-REFERENCE TO RELATED APPLICATIONS

This application is the U.S. National Stage of International Patent Application No. PCT/KR2021/015554 filed on Nov. 1, 2021, which claims priority to and the benefit of Korean Patent Application No. 10-2020-0143754, filed on Oct. 30, 2020, and Korean Patent Application No. 10-2021-0147166, filed on Oct. 29, 2021, the disclosures of which are incorporated herein by reference in their entireties.

### TECHNICAL FIELD

The present invention relates to an electronic brake system, and more specifically, to an electronic brake system for generating a braking force using an electrical signal corresponding to the displacement of a brake pedal.

### BACKGROUND ART

Vehicles are essentially equipped with a brake system for performing braking, and various types of brake systems have been proposed for the safety of drivers and passengers.

In conventional brake systems, a method of supplying a hydraulic pressure required for braking to wheel cylinders using a mechanically connected booster when a driver steps on a brake pedal has been mainly used. However, as the market demand for implementing various braking functions specifically in response to operating environments of vehicles increases, recently, an electronic brake system for receiving a driver's braking intention as an electrical signal from a pedal displacement sensor for detecting the displacement of a brake pedal when a driver steps on the brake pedal and operating a hydraulic pressure supply device based on the electrical signal to supply a hydraulic pressure required for braking to wheel cylinders has been widely used.

Such an electronic brake system receives a driver's manipulation of the brake pedal in a normal operation mode or generates and provides braking determination during autonomous traveling of a vehicle as an electrical signal and generates and transmits a hydraulic pressure required for braking to wheel cylinders by the hydraulic pressure supply device electrically operated and controlled based on the electrical signal. As described above, the electronic brake system and a method of operating the same may implement complicated and various braking operations because they are electrically operated and controlled, but there is a concern that when technical problems occur in electronic components, the hydraulic pressure required for braking is not stably generated, thereby threatening passengers' safety.

### Technical Problem

The present embodiment is directed to providing an electronic brake system capable of effectively performing braking even in various operation situations.

The present embodiment is directed to providing an electronic brake system with improved braking performance and operation reliability.

The present embodiment is directed to providing an electronic brake system capable of performing various braking operation modes through a simple structure and operation.

The present embodiment is directed to providing an electronic brake system with improved durability of a product by reducing loads applied to components.

The present embodiment is directed to providing an electronic brake system capable of improving assemblability and productivity of a product and also saving manufacturing costs of the product.

### Technical Solution

In accordance with one aspect of the present invention, an electronic brake system includes a pedal unit connected to a brake pedal and operated by a driver's pedal force, and a hydraulic pressure providing unit configured to generate a hydraulic pressure of a pressurizing medium for braking a vehicle based on an electrical signal output in response to displacement of the brake pedal, wherein the pedal unit includes a pedal simulator configured to generate a reaction force to a pedal force of the brake pedal and provide a pedal feel to the driver, the hydraulic pressure providing unit includes a hydraulic pressure supply device configured to generate the hydraulic pressure of the pressurizing medium by operating a hydraulic piston by the electrical signal, a first hydraulic circuit configured to control flows of pressurizing media supplied to a first wheel cylinder and a second wheel cylinder, a second hydraulic circuit configured to control flows of pressurizing media supplied to a third wheel cylinder and a fourth wheel cylinder, and a hydraulic pressure control device configured to control flows of pressurizing media that is supplied from the hydraulic pressure supply device to the first and second hydraulic circuits or returned from the first and second hydraulic circuits to the hydraulic pressure supply device, and the pedal unit and the hydraulic pressure providing unit are disposed to be physically separated from each other on a vehicle body.

The hydraulic pressure providing unit may further include a reservoir in which the pressurizing medium is stored, the first hydraulic circuit may include a first inlet valve and a second inlet valve respectively provided at inlet sides of the first wheel cylinder and the second wheel cylinder to control the flows of the pressurizing media, and a first outlet valve and a second outlet valve respectively provided at outlet sides of the first wheel cylinder and the second wheel cylinder to control the flows of the pressurizing media discharged to the reservoir, and the second hydraulic circuit may include a third inlet valve and a fourth inlet valve respectively provided at inlet sides of the third wheel cylinder and the fourth wheel cylinder to control the flows of the pressurizing media, and a third outlet valve and a fourth outlet valve respectively provided at outlet sides of the third wheel cylinder and the fourth wheel cylinder to control the flows of the pressurizing media discharged to the reservoir.

The first to fourth outlet valves may each be provided as a normal open type solenoid valve that is normally open and then operated to be closed upon receiving an electrical signal.

The first to fourth outlet valves may each be provided as a normal closed type solenoid valve that is normally closed and then operated to be opened upon receiving an electrical signal.

Any one of the first and second outlet valves may be provided as a normal open type solenoid valve that is normally open and then operated to be closed upon receiving an electrical signal, the other one of the first and second outlet valves may be provided as a normal closed type solenoid valve that is normally closed and then operated to be opened upon receiving an electrical signal, any one of the third and fourth outlet valves may be provided as a normal open type solenoid valve that is normally open and then operated to be closed upon receiving an electrical signal, and the other one of the third and fourth outlet valves may be provided as a normal closed type solenoid valve that is normally closed and then operated to be opened upon receiving an electrical signal.

The pedal simulator may be provided to include a simulation piston displaced by the operation of the brake pedal, a simulation chamber whose volume is changed by the displacement of the simulation piston, and an elastic member provided in the simulation chamber, compressed by the displacement of the simulation piston, and configured to provide the pedal feel through an elastic restoring force generated from the compression.

The hydraulic pressure supply device may further include a first pressure chamber provided at one side of the hydraulic piston, and a second pressure chamber provided at the other side of the hydraulic piston, and the hydraulic pressure control device may be provided to include a first hydraulic flow path communicating with the first pressure chamber, a second hydraulic flow path communicating with the second pressure chamber, a third hydraulic flow path to which the first hydraulic flow path and the second hydraulic flow path are joined, a fourth hydraulic flow path branched off from the third hydraulic flow path and connected to the first hydraulic circuit, a fifth hydraulic flow path branched off from the third hydraulic flow path and connected to the second hydraulic circuit, a sixth hydraulic flow path communicating with the first hydraulic circuit, a seventh hydraulic flow path communicating with the second hydraulic flow path, an eighth hydraulic flow path to which the sixth hydraulic flow path and the seventh hydraulic flow path are joined, a ninth hydraulic flow path branched off from the eighth hydraulic flow path and connected to the first pressure chamber, and a tenth hydraulic flow path branched off from the eighth hydraulic flow path and connected to the second pressure chamber.

The hydraulic pressure control device may be provided to include a first valve provided on the first hydraulic flow path to control the flow of the pressurizing medium, a second valve provided on the second hydraulic flow path to control the flow of the pressurizing medium, a third valve provided on the fourth hydraulic flow path to control the flow of the pressurizing medium, a fourth valve provided on the fifth hydraulic flow path to control the flow of the pressurizing medium, a fifth valve provided on the sixth hydraulic flow path to control the flow of the pressurizing medium, a sixth valve provided on the seventh hydraulic flow path to control the flow of the pressurizing medium, a seventh valve provided on the ninth hydraulic flow path to control the flow of the pressurizing medium, and an eighth valve provided on the tenth hydraulic flow path to control the flow of the pressurizing medium.

The first valve may be provided as a check valve configured to allow only a flow of the pressurizing medium discharged from the first pressure chamber, the second valve may be provided as a check valve configured to allow only a flow of the pressurizing medium discharged from the second pressure chamber, the third valve may be provided as a check valve configured to allow only a flow of the pressurizing medium from the third hydraulic flow path toward the first hydraulic circuit, the fourth valve may be provided as a check valve configured to allow only a flow of the pressurizing medium from the third hydraulic flow path toward the second hydraulic circuit, the fifth valve may be provided as a check valve configured to allow only a flow of the pressurizing medium discharged from the first hydraulic circuit, the sixth valve may be provided as a check valve configured to allow only a flow of the pressurizing medium discharged from the second hydraulic circuit, and the seventh valve and the eighth valve may be provided as a solenoid valve configured to control the flow of the pressurizing medium in both directions.

The hydraulic pressure providing unit may further include a hydraulic dumper provided between the reservoir and the hydraulic pressure supply device to control the flow of the pressurizing medium, and the hydraulic dumper may be provided to include a first dump flow path connecting the first pressure chamber and the reservoir, a second dump flow path connecting the second pressure chamber and the reservoir, a first dump valve provided on the first dump flow path to control the flow of the pressurizing medium, and a second dump valve provided on the second dump flow path to control the flow of the pressurizing medium.

The reservoir may be provided to include a first reservoir chamber connected to the hydraulic dumper, a second reservoir chamber connected to the first hydraulic circuit side, and a third reservoir chamber connected to the second hydraulic circuit side.

The hydraulic pressure providing unit may be provided to further include a hydraulic pressure auxiliary device configured to operate when the hydraulic pressure supply device is inoperable so as to auxiliarily provide the hydraulic pressure of the pressurizing medium to the first and second hydraulic circuits through.

The hydraulic pressure auxiliary device may be provided to include a first hydraulic pump and a second hydraulic pump configured to generate the hydraulic pressure of the pressurizing medium, a first auxiliary hydraulic flow path connecting a discharge end of the first hydraulic pump and the first hydraulic circuit, a second auxiliary hydraulic flow path connecting a discharge end of the second hydraulic pump and the second hydraulic circuit, a first auxiliary discharge flow path connecting downstream sides of the first and second outlet valves and a suction end of the first hydraulic pump, and a second auxiliary discharge flow path connecting downstream sides of the third and fourth outlet valves and a suction end of the second hydraulic pump.

The hydraulic pressure auxiliary device may be provided to further include a backup motor configured to operate the first and second hydraulic pumps.

The hydraulic pressure providing unit may be provided to further include a first electronic control unit configured to control operation of the hydraulic pressure supply device, and a second electronic control unit configured to control operation of the hydraulic pressure auxiliary device.

### Advantageous Effects

An electronic brake system according to the present embodiment can stably and effectively implement braking in various operation situations of a vehicle.

The electronic brake system according to the present embodiment can perform various braking operation modes through a simple structure and operation.

The electronic brake system according to the present embodiment can improve braking performance and operation reliability.

The electronic brake system according to the present embodiment can stably provide a braking pressure even when components fail or a pressurizing medium leaks.

The electronic brake system according to the present embodiment can improve the durability of a product by reducing loads applied to components.

The electronic brake system according to the present embodiment can improve the assemblability and productivity of a product and at the same time, save manufacturing costs of the product.

### DESCRIPTION OF DRAWINGS

FIG. 1 is a hydraulic circuit diagram illustrating an electronic brake system according to a first embodiment of the present invention.

FIG. 2 is a hydraulic circuit diagram illustrating a state in which the electronic brake system according to the first embodiment of the present invention performs a first braking mode.

FIG. 3 is a hydraulic circuit diagram illustrating a state in which the electronic brake system according to the first embodiment of the present invention performs a second braking mode.

FIG. 4 is a hydraulic circuit diagram illustrating a state in which the electronic brake system according to the first embodiment of the present invention performs a third braking mode.

FIG. 5 is a hydraulic circuit diagram illustrating an electronic brake system according to a second embodiment of the present invention.

FIG. 6 is a hydraulic circuit diagram illustrating an electronic brake system according to a third embodiment of the present invention.

FIG. 7 is a hydraulic circuit diagram illustrating an electronic brake system according to a fourth embodiment of the present invention.

FIG. 8 is a hydraulic circuit diagram illustrating a state in which the electronic brake system according to the fourth embodiment of the present invention performs an emergency braking mode.

### MODES OF THE INVENTION

Hereinafter, embodiments of the present invention will be described in detail with reference to the accompanying drawings. The following embodiments are presented to sufficiently convey the spirit of the present invention to those skilled in the art to which the present invention pertains. The present invention may also be specified in other forms without being limited to only the embodiments presented herein. In the drawings, in order to clarify the present invention, illustration of parts irrelevant to the description may be omitted, and the sizes of components may be slightly exaggerated to help understanding.

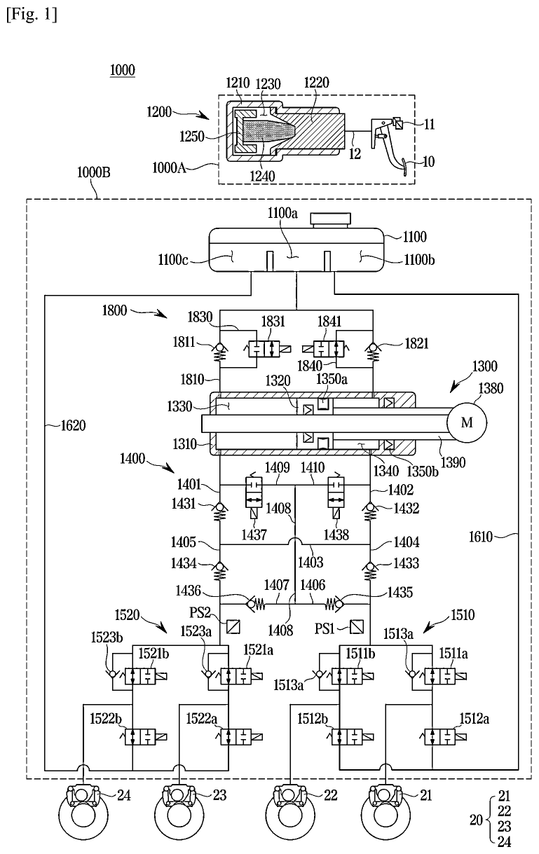

FIG. 1 is a hydraulic circuit diagram illustrating an electronic brake system 1000 according to a first embodiment of the present invention.

Referring to FIG. 1, the electronic brake system 1000 according to the first embodiment of the present invention may include a pedal unit 1000A operated by a driver's pedal force applied on a brake pedal 10, and a hydraulic pressure providing unit 1000B for generating and providing a hydraulic pressure of a pressurizing medium for braking based on an electrical signal output according to displacement of the brake pedal 10, and the pedal unit 1000A and the hydraulic pressure providing unit 1000B may be provided to be physically separated from each other.

Since the pedal unit 1000A and the hydraulic pressure providing unit 1000B are provided in a vehicle in a state of being physically separated from each other, it is possible to improve a degree of freedom of installation of the electronic brake system 1000. For example, the pedal unit 1000A may be disposed close to a passenger space of a vehicle considering that the pedal unit 1000A is connected to the brake pedal 10 to be operated, and the hydraulic pressure providing unit 1000B may be installed on a portion in which a spatial room is present, such as an engine room or a luggage room of the vehicle, or installed in a space in which flow paths for transmitting the hydraulic pressure of the pressurizing medium may be efficiently disposed, thereby facilitating the installation work of the electronic brake system and improving the space utilization of the vehicle.

Furthermore, today, as an autonomous traveling technology of vehicles gradually develops, since the brake determination of the vehicle is generated as an electrical signal by a camera, a radar, or the like and a hydraulic pressure of a pressurizing medium for braking the vehicle is automatically generated based on the electrical signal, the braking of the vehicle regardless of an operation of the brake pedal 10 is required. Therefore, the electronic brake system 1000 according to the present embodiment may physically separate the pedal unit 1000A connected to the brake pedal 10 and the hydraulic pressure providing unit 1000B for generating the hydraulic pressure of the pressurizing medium for braking the vehicle to block the interworking of the brake pedal 10 during braking in an autonomous traveling situation of a vehicle, thereby preventing a driver's manipulation confusion and achieving a comfortable passenger space.

The pedal unit 1000A is operated by a driver's pedal force of the brake pedal 10 and includes a pedal simulator 1200 for providing a pedal feel to the driver.

Specifically, when the driver applies the pedal force to the brake pedal 10 for a braking operation, the pedal simulator 1200 is provided to provide a stable pedal feel by providing the driver with a reaction force to the pedal force.

The pedal simulator 1200 may include a cylinder body 1210, a simulation piston 1220 connected to the brake pedal 10 and provided to be displaced by the operation of the brake pedal 10, a simulation chamber 1230 provided inside the cylinder body 1210 and whose volume is changed by the displacement of the simulation piston 1220, and an elastic member 1240 provided in the simulation chamber 1230 to provide a pedal feel through an elastic restoring force generated upon compression.

The simulation chamber 1230 may be formed inside the cylinder body 1210, and the simulation piston 1220 may be connected to the brake pedal 10 via an input rod 12 and accommodated to make a reciprocating movement in the simulation chamber 1230. By providing the elastic member 1240 in the simulation chamber 1230, the elastic member 1240 may be compressed by the forward movement of the simulation piston 1220 (in a left direction based on FIG. 1), and the elastic member 1240 may be restored to an original state by the backward movement of the simulation piston 1220 (in a right direction based on FIG. 1).

Specifically, one side of the elastic member 1240 may be installed in contact with a front surface (left side surface based on FIG. 1) of the simulation piston 1220, and the elastic member 1240 may be made of an elastic material such as compressible and expandable rubber. The other side of the elastic member 1240 may be in direct contact with an inner end of the cylinder body 1210 or, as illustrated in FIG. 1, may be provided in a state in which a part thereof is seated on a support member 1250 installed on the inner end of the cylinder body 1210. The elastic member 1240 may include a cylindrical body part of which at least a part is inserted into and supported by the support member 1250, and a tapered part of which at least a part is inserted into and supported by the front surface of the simulation piston 1220 and having a diameter gradually reduced rearward (toward a right side based on FIG. 1). At least a part of each of both ends of the elastic member 1240 may be inserted into and stably supported by each of the simulation piston 1220 and the support member 1250, and an elastic restoring force may be changed by the tapered part according to a degree of the pedal force of the brake pedal 10, thereby providing a stable and familiar pedal feel to the driver.

Describing a pedal simulation operation by the pedal simulator 1200, as the driver operates the brake pedal 10, the simulation piston 1220 compresses the elastic member 1240 while moving forward. The compressed elastic member 1240 may generate an elastic restoring force, and the corresponding elastic restoring force may be provided to the driver as a pedal feel. Thereafter, when the driver releases the pedal force of the brake pedal 10, the simulation piston 1220 and the elastic member 1240 may return to original shapes and positions due to the elastic restoring force of the elastic member 1240 and return to a braking standby state.

The simulation chamber 1230 may be provided in a state of being filled with lubricating oil, thereby reducing abrasion of components despite repetitive operations of the brake pedal 10 and the simulation piston 1220 and suppressing noises and vibrations generated upon operation.

The hydraulic pressure providing unit 1000B is provided to generate and provide the hydraulic pressure of the pressurizing medium for braking the vehicle based on the electrical signal output in response to the displacement of the brake pedal 10.

The hydraulic pressure providing unit 1000B includes a reservoir 1100 in which the pressurizing medium is stored, a hydraulic pressure supply device 1300 for receiving a driver's braking intention as an electrical signal by a pedal displacement sensor 11 for detecting the displacement of the brake pedal 10 and generating the hydraulic pressure of the pressurizing medium through a mechanical operation, a hydraulic pressure control device 1400 for controlling the hydraulic pressure of the pressurizing medium discharged from the hydraulic pressure supply device 1300 or returned to the hydraulic pressure supply device 1300, first and second hydraulic circuits 1510 and 1520 including wheel cylinders 21, 22, 23, and 24 for performing braking on each of wheels RR, RL, FR, and FL, a hydraulic dumper 1800 provided between the hydraulic pressure supply device 1300 and the reservoir 110 to control the flow of the pressurizing medium, and a first electronic control unit (ECU) ECU1 (not illustrated) for controlling various valves of the hydraulic pressure supply device 1300 and the hydraulic pressure control device 1400 based on hydraulic information and pedal displacement information.

The reservoir 1100 may accommodate and store the pressurizing medium therein. The reservoir 1100 may be connected to a plurality of components, such as the hydraulic pressure supply device 1300, the first and second hydraulic circuits 1510 and 1520, and the hydraulic dumper 1800, which will be described below, to supply or receive the pressurizing medium. The reservoir 1100 may include a first reservoir chamber 1100a connected to the hydraulic pressure supply device 1300 via the hydraulic dumper 1800, which will be described below, a second reservoir chamber 1100b connected to the first hydraulic circuit 1510, which will be described below, via a first discharge flow path 1610 and a third reservoir chamber 1100c connected to the second hydraulic circuit 1510, which will be described below, via a second discharge flow path 1620 and the reservoir chambers 1100a, 1100b, and 1100c may be partitioned through partition walls. The reservoir 1100 may be partitioned into the plurality of reservoir chambers 1100a, 1100b, and 1100c by the partition walls, and even when the flow of the pressurizing medium is concentrated on one component, each of the plurality of reservoir chambers 1100a, 1100b, and 1100c may be connected to a different component to stably supply the pressurizing medium to another component.

The hydraulic pressure supply device 1300 is provided to receive the driver's braking intention as the electrical signal from the pedal displacement sensor 11 for detecting the displacement of the brake pedal 10 and generate the hydraulic pressure of the pressurizing medium through the mechanical operation.

The hydraulic pressure supply device 1300 includes

a cylinder block 1310 provided to accommodate the pressurizing medium, a hydraulic piston 1320 accommodated in the cylinder block 1310, a sealing member 1350 provided between the hydraulic piston 1320 and the cylinder block 1310 to seal pressure chambers 1330 and 1340, a main motor 1380 for generating a rotating force by the electrical signal of the pedal displacement sensor 11, a power converter (not illustrated) for converting a rotating motion of the main motor 1380 into a linear motion and transmitting the linear motion to the hydraulic piston 1320, and a driving shaft 1390 for transmitting a power output from the power converter to the hydraulic piston 1320.

The pressure chambers 1330 and 1340 may include the first pressure chamber 1330 positioned in front of the hydraulic piston 1320 (in a left direction of the hydraulic piston 1320 based on FIG. 1) and the second pressure chamber 1340 positioned behind the hydraulic piston 1320 (in a right direction of the hydraulic piston 1320 based on FIG. 1). That is, the first pressure chamber 1330 is provided to be partitioned by the cylinder block 1310 and a front surface of the hydraulic piston 1320 and provided to have a volume changed depending on the movement of the hydraulic piston 1320, and the second pressure chamber 1340 is provided to be partitioned by the cylinder block 1310 and a rear surface of the hydraulic piston 1320 and provided to have a volume changed depending on the movement of the hydraulic piston 1320.

The first pressure chamber 1330 is connected to a first hydraulic flow path 1401 to be described below through a communication hole formed in the cylinder block 1310, and the second pressure chamber 1340 is connected to a second hydraulic flow path 1402 to be described below through a communication hole formed in the cylinder block 1310.

The sealing member includes a piston sealing member 1350a provided between the hydraulic piston 1320 and the cylinder block 1310 to seal the first pressure chamber 1330 and the second pressure chamber 1340, and a driving shaft sealing member 1350b provided between the driving shaft 1390 and the cylinder block 1310 to seal the second pressure chamber 1340 and an opening of the cylinder block 1310. Hydraulic pressures or negative pressures of the first pressure chamber 1330 and the second pressure chamber 1340 generated by the forward movement or backward movement of the hydraulic piston 1320 may keep inside of by the piston sealing member 1350a and the driving shaft sealing member 1350b and may be transmitted to the first hydraulic flow path 1401 and the second hydraulic flow path 1402, which will be described below, without leakage.

The main motor 1380 is provided to generate a driving force of the hydraulic piston 1320 by the electrical signal output from the first ECU ECU1. The main motor 1380 may be provided to include a stator and a rotor and may provide a power for generating the displacement of the hydraulic piston 1320 by rotating in a forward direction or a reverse direction through the stator and the rotor. A rotating angular velocity and a rotating angle of the main motor 1380 may be precisely controlled by a motor control sensor. Since the motor is a well-known technology, a detailed description thereof will be omitted.

The power converter (not illustrated) is provided to convert the rotating force of the main motor 1380 into the linear motion. The power converter may be provided in a structure including, for example, a worm shaft (not illustrated), a worm wheel (not illustrated), and the driving shaft 1390. The worm shaft may be integrally formed with a rotating shaft of the motor and may have a worm formed on an outer circumferential surface thereof to be coupled to be engaged with the worm wheel to rotate the worm wheel. The worm wheel may be connected to be engaged with the driving shaft 1390 to linearly move the driving shaft 1390, and the driving shaft 1390 may be connected to the hydraulic piston 1320 to operate integrally, and thus the hydraulic piston 1320 may slide in the cylinder block 1310.

Describing the above-described operations again, when the displacement of the brake pedal 10 is detected by the pedal displacement sensor 11, the detected signal is transmitted to the first ECU ECU1, and the first ECU ECU1 drives the main motor 1380 to rotate the worm shaft in one direction. A rotating force of the worm shaft may be transmitted to the driving shaft 1390 through the worm wheel, and the hydraulic piston 1320 connected to the driving shaft 1390 may generate a hydraulic pressure in the first pressure chamber 1330 while moving forward in the cylinder block 1310.

Conversely, when the pedal force of the brake pedal 10 is released, the first ECU ECU1 drives the main motor 1380 to rotate the worm shaft in a reverse direction. Therefore, the worm wheel may also rotate in the reverse direction, and the hydraulic piston 1320 connected to the driving shaft 1390 may generate a negative pressure in the first pressure chamber 1330 while moving backward in the cylinder block 1310.

The generation of a hydraulic pressure and a negative pressure in the second pressure chamber 1340 may be implemented by an operation in a direction opposite to the above direction. That is, when the displacement of the brake pedal is detected by the pedal displacement sensor 11, the detected signal is transmitted to the first ECU ECU1, and the first ECU ECU1 drives the main motor 1380 to rotate the worm shaft in the reverse direction. The rotating force of the worm shaft may be transmitted to the driving shaft 1390 through the worm wheel, and the hydraulic piston 1320 connected to the driving shaft 1390 may generate a hydraulic pressure in the second pressure chamber 1340 while moving backward in the cylinder block 1310.

Conversely, when the pedal force of the brake pedal 10 is released, the first ECU ECU1 drives the main motor 1380 in one direction to rotate the worm shaft in the one direction. Therefore, the worm wheel may also rotate in the one direction, and the hydraulic piston 1320 connected to the driving shaft 1390 may generate a negative pressure in the second pressure chamber 1340 while moving forward in the cylinder block 1310.

As described above, the hydraulic pressure may be generated or the negative pressure may be generated in each of the first pressure chamber 1330 and the second pressure chamber 1340 according to the rotating direction of the worm shaft by the driving of the main motor 1380, the hydraulic pressure supply device 1300 may control valves to determine whether to transmit the hydraulic pressure to implement braking or whether to release braking using the negative pressure. A detailed description thereof will be given below.

Meanwhile, the power converter according to the present embodiment is not limited to any one structure as long as the power converter can convert the rotating motion of the main motor 1380 into the linear motion of the hydraulic piston 1320, and it should be identically understood even when the power converter is configured as devices that have various structures and perform methods.

The hydraulic pressure supply device 1300 may be hydraulically connected to the first reservoir chamber 1100a of the reservoir 1100 by the hydraulic dumper 1800. The hydraulic dumper 1800 may include a first hydraulic dumper for controlling the flow of the pressurizing medium between the first pressure chamber 1330 and the reservoir 1100, and a second hydraulic dumper for controlling the flow of the pressurizing medium between the second pressure chamber 1340 and the reservoir 1100. The first hydraulic dumper may include a first dump flow path 1810 connecting the first pressure chamber 1330 and the reservoir 1100, and a first bypass flow path 1830 rejoined after branched off from the first dump flow path 1810, and the second hydraulic dumper may include a second dump flow path 1820 connecting the second pressure chamber 1340 and the reservoir 1100, and a second bypass flow path 1840 rejoined after branched off from the second dump flow path 1820.

The first dump flow path 1810 and the first bypass flow path 1830 may be respectively provided with a first dump check valve 1811 and a first dump valve 1831 for controlling the flow of the pressurizing medium. The first dump check valve 1811 may be provided to allow only the flow of the pressurizing medium from the reservoir 1100 toward the first pressure chamber 1330 and block the flow of the pressurizing medium in a reverse direction. In the first dump flow path 1810, the first bypass flow path 1830 may be connected parallel to the first dump check valve 1811, and in the first bypass flow path 1830, the first dump valve 1831 configured to control the flow of the pressurizing medium between the first pressure chamber 1330 and the reservoir 1100 may be provided. That is, the first bypass flow path 1830 may connect a front end and a rear end of the first dump check valve 1811 to bypass the first dump check valve 1811 on the first dump flow path 1810, and the first dump valve 1831 may be provided as a bidirectional solenoid valve for controlling the flow of the pressurizing medium between the first pressure chamber 1330 and the reservoir 1100. The first dump valve 1831 may be provided as a normal closed type solenoid valve that is normally in a closed state and then operated so that the valve is opened upon receiving the electrical signal from the first ECU.

The second dump flow path 1820 and the second bypass flow path 1840 may be respectively provided with a second dump check valve 1821 and a second dump valve 1841 for controlling the flow of the pressurizing medium. The second dump check valve 1821 may be provided to allow only the flow of the pressurizing medium from the reservoir 1100 toward the second pressure chamber 1330 and block the flow of the pressurizing medium in a reverse direction. The second bypass flow path 1840 may be connected parallel to the second dump check valve 1821 on the second dump flow path 1820, and the second dump valve 1841 for controlling the flow of the pressurizing medium between the second pressure chamber 1330 and the reservoir 1100 may be provided on the second bypass flow path 1840. That is, the second bypass flow path 1840 may connect a front end and a rear end of the second dump check valve 1821 to bypass the second dump check valve 1821 on the second dump flow path 1820, and the second dump valve 1841 may be provided as a bidirectional solenoid valve for controlling the flow of the pressurizing medium between the second pressure chamber 1330 and the reservoir 1100. The second dump valve 1841 may be provided as a normal open type solenoid valve that is normally open and then operated so that the valve is closed upon receiving an electrical signal from a first ECU.

The hydraulic pressure control device 1400 may be provided to control the flow of the pressurizing media from the hydraulic pressure supply device 1300 toward each of the wheel cylinders 21, 22, 23, and 24 or the flow of the pressurizing media returned to the hydraulic pressure supply device 1300 from each of the wheel cylinders 21, 22, 23, and 24. To this end, the hydraulic pressure control device 1400 includes a plurality of flow paths and valves to smoothly control the flow or hydraulic pressures of the pressurizing media.

The first hydraulic circuit 1510 for controlling the flow of the pressurizing medium may be provided between the hydraulic pressure control device 1400 and the two wheel cylinders 21 and 22, and the second hydraulic circuit 1520 for controlling the flow of the pressurizing medium may be provided between the hydraulic pressure control device 1400 and the other two wheel cylinders 23 and 24.

The first hydraulic flow path 1401 may be provided to communicate with the first pressure chamber 1330, and the second hydraulic flow path 1402 may be provided to communicate with the second pressure chamber 1340. The first hydraulic flow path 1401 and the second hydraulic flow path 1402 may be provided to be joined to a third hydraulic flow path 1403 and then re-branched off to a fourth hydraulic flow path 1404 connected to the first hydraulic circuit 1510 and a fifth hydraulic flow path 1405 connected to the second hydraulic circuit 1520.

A sixth hydraulic flow path 1406 is provided to communicate with the first hydraulic circuit 1510, and a seventh hydraulic flow path 1407 is provided to communicate with the second hydraulic circuit 1520. The sixth hydraulic flow path 1406 and the seventh hydraulic flow path 1407 may be provided to be joined to an eighth hydraulic flow path 1408 and then re-branched off to a ninth hydraulic flow path 1409 communicating with the first pressure chamber 1330 and a tenth hydraulic flow path 1410 communicating with the second pressure chamber 1340.

A first valve 1431 for controlling the flow of the pressurizing medium may be provided on the first hydraulic flow path 1401. The first valve 1431 may be provided as a check valve for allowing the flow of the pressurizing medium discharged from the first pressure chamber 1330 and blocking the flow of the pressurizing medium in a reverse direction. In addition, the second hydraulic flow path 1402 may be provided with a second valve 1432 for controlling the flow of the pressurizing medium, and the second valve 1432 may be provided as a check valve for allowing the flow of the pressurizing medium discharged from the second pressure chamber 1340 and blocking the flow of the pressurizing medium in a reverse direction.

The fourth hydraulic flow path 1404 is provided to be re-branched off from the third hydraulic flow path 1403 to which the first hydraulic flow path 1401 and the second hydraulic flow path 1402 are joined and connected to the first hydraulic circuit 1510. A third valve 1433 for controlling the flow of the pressurizing medium may be provided on the fourth hydraulic flow path 1404. The third valve 1433 may be provided as a check valve for allowing the pressurizing medium to flow only from the third hydraulic flow path 1403 toward the first hydraulic circuit 1510 and blocking the flow of the pressurizing medium in a reverse direction.

The fifth hydraulic flow path 1405 is provided to be re-branched off from the third hydraulic flow path 1403 to which the first hydraulic flow path 1401 and the second hydraulic flow path 1402 are joined and connected to the second hydraulic circuit 1520. A fourth valve 1434 for controlling the flow of the pressurizing medium may be provided on the fifth hydraulic flow path 1405. The fourth valve 1434 may be provided as a check valve for allowing the pressurizing medium to flow only from the third hydraulic flow path 1403 toward the second hydraulic circuit 1520 and blocking the flow of the pressurizing medium in a reverse direction.

The sixth hydraulic flow path 1406 communicates with the first hydraulic circuit 1510, the seventh hydraulic flow path 1407 communicates with the second hydraulic circuit 1520, and the sixth hydraulic flow path 1406 and the seventh hydraulic flow path 1407 are provided to be joined to the eighth hydraulic flow path 1408. A fifth valve 1435 for controlling the flow of the pressurizing medium may be provided on the sixth hydraulic flow path 1406. The fifth valve 1435 may be provided as a check valve for allowing only the flow of the pressurizing medium discharged from the first hydraulic circuit 1510 and blocking the flow of the pressurizing medium in a reverse direction. In addition, a sixth valve 1436 for controlling the flow of the pressurizing medium may be provided on the seventh hydraulic flow path 1407. The sixth valve 1436 may be provided as a check valve for allowing only the flow of the pressurizing medium discharged from the second hydraulic circuit 1520 and blocking the flow of the pressurizing medium in a reverse direction.

The ninth hydraulic flow path 1409 is provided to be branched off from the eighth hydraulic flow path 1408 to which the sixth hydraulic flow path 1406 and the seventh hydraulic flow path 1407 are joined and connected to the first pressure chamber 1330. A seventh valve 1437 for controlling the flow of the pressurizing medium may be provided on the ninth hydraulic flow path 1409. The seventh valve 1437 may be provided as a bidirectional control valve for controlling the flow of the pressurizing medium transmitted along the ninth hydraulic flow path 1409. The seventh valve 1437 may be provided as a normal closed type solenoid valve that is normally in a closed state and then operated so that the valve is opened upon receiving an electrical signal from a first ECU.

The tenth hydraulic flow path 1410 is provided to be branched off from the eighth hydraulic flow path 1408 to which the sixth hydraulic flow path 1406 and the seventh hydraulic flow path 1407 are joined and connected to the second pressure chamber 1340. An eighth valve 1438 for controlling the flow of the pressurizing medium may be provided on the tenth hydraulic flow path 1410. The eighth valve 1438 may be provided as a bidirectional control valve for controlling the flow of the pressurizing medium transmitted along the tenth hydraulic flow path 1410. Like the seventh valve 1437, the eighth valve 1438 may be provided as a normal closed type solenoid valve that is normally in a closed state and then operated so that the valve is opened upon receiving an electrical signal from a first ECU.

By the placement of these hydraulic flow paths and the valves of the hydraulic pressure control device 1400, the hydraulic pressure, which has been generated in the first pressure chamber 1330 due to the forward movement of the hydraulic piston 1320, may be transmitted to the first hydraulic circuit 1510 after sequentially passing the first hydraulic flow path 1401, the third hydraulic flow path 1403, and the fourth hydraulic flow path 1404 and transmitted to the second hydraulic circuit 1520 after sequentially passing the first hydraulic flow path 1401 and the fifth hydraulic flow path 1405. In addition, the hydraulic pressure generated in the second pressure chamber 1340 due to the backward movement of the hydraulic piston 1320 may be transmitted to the first hydraulic circuit 1510 after sequentially passing the second hydraulic flow path 1402 and the fourth hydraulic flow path 1404 and transmitted to the second hydraulic circuit 1520 after sequentially passing the second hydraulic flow path 1402, the third hydraulic flow path 1403, and the fifth hydraulic flow path 1405.

Conversely, due to the negative pressure generated in the first pressure chamber 1330 due to the backward movement of the hydraulic piston 1320, the pressurizing medium provided to the first hydraulic circuit 1510 may be returned to the first pressure chamber 1330 after sequentially passing the sixth hydraulic flow path 1406, the eighth hydraulic flow path 1408, and the ninth hydraulic flow path 1409, and the pressurizing medium provided to the second hydraulic circuit 1520 may be returned to the first pressure chamber 1330 after sequentially passing the seventh hydraulic flow path 1407, the eighth hydraulic flow path 1408, and the ninth hydraulic flow path 1409. In addition, due to the negative pressure generated in the second pressure chamber 1340 due to the forward movement of the hydraulic piston 1320, the pressurizing medium provided to the first hydraulic circuit 1510 may be returned to the first pressure chamber 1330 after sequentially passing the sixth hydraulic flow path 1406, the eighth hydraulic flow path 1408, and the tenth hydraulic flow path 1410, and the pressurizing medium provided to the second hydraulic circuit 1520 may be returned to the second pressure chamber 1340 after sequentially passing the seventh hydraulic flow path 1407, the eighth hydraulic flow path 1408, and the tenth hydraulic flow path 1410.

The first hydraulic circuit 1510 of the hydraulic pressure control device 140 may control the hydraulic pressures of the first and second wheel cylinders 21 and 22, which are two wheel cylinders among wheel cylinders of four wheels RR, RL, FR, and FL, and the second hydraulic circuit 1520 may control the hydraulic pressures of the third and fourth wheel cylinders 23 and 24, which are the other two wheel cylinders.

The first hydraulic circuit 1510 may receive the hydraulic pressure through the fourth hydraulic flow path 1404 and discharge the hydraulic pressure to the hydraulic pressure supply device 1300 through the sixth hydraulic flow path 1406. To this end, as illustrated in FIG. 1, the fourth hydraulic flow path 1404 and the sixth hydraulic flow path 1406 are provided to be joined and then branched off to two flow paths connected to the first wheel cylinder 21 and the second wheel cylinder 22. In addition, the second hydraulic circuit 1520 may receive the hydraulic pressure through the fifth hydraulic flow path 1405 and discharge the hydraulic pressure to the hydraulic pressure supply device 1300 through the seventh hydraulic flow path 1407, and thus, as illustrated in FIG. 1, the fifth hydraulic flow path 1405 and the seventh hydraulic flow path 1407 are joined and then branched off to two flow paths connected to the third wheel cylinder 23 and the fourth wheel cylinder 24. However, the connection of the hydraulic flow paths illustrated in FIG. 1 is an example for helping understanding of the present invention and is not limited to this structure, and it should be identically understood even when the hydraulic flow paths are connected in various methods and structures as in a case in which each of the fourth hydraulic flow path 1404 and the sixth hydraulic flow path 1406 may each be connected to the first hydraulic circuit 1510 and independently branched off and connected to the first wheel cylinder 21 and the second wheel cylinder 22, respectively, and likewise, the fifth hydraulic flow path 1405 and the seventh hydraulic flow path 1407 may each be connected to the second hydraulic circuit 1520 and independently branched off and connected to the third wheel cylinder 23 and the fourth wheel cylinder 24, respectively.

The first and second hydraulic circuits 1510 and 1520 may include first to fourth inlet valves 1511a, 1511b, 1521a, and 1521b to respectively control the flow and hydraulic pressures of the pressurizing media transmitted to the first to fourth wheel cylinders 21, 22, 23, and 24. The first to fourth inlet valves 1511a, 1511b, 1521a, and 1521b may be respectively disposed at upstream sides of the first to fourth wheel cylinders 21, 22, 23, 24 and may each be provided as a normal open type solenoid valve that is normally open and then operated so that the valve is closed upon receiving an electrical signal from an ECU.

Meanwhile, operations of the first and second hydraulic circuits 1510 and 1520 may be controlled by an auxiliary ECU provided independently of the first ECU ECU1. Since the auxiliary ECU may be provided to transmit an electrical signal separately from the signal of the first ECU ECU1, it is possible to stably control the operations of the first hydraulic circuits 1510 and 1520 even when the first ECU ECU1 is inoperable. Furthermore, the auxiliary ECU may also be provided to receive a power separately from the power of the first ECU ECU1.

The first and second hydraulic circuits 1510 and 1520 may include first to fourth check valves 1513a, 1513b, 1523a, and 1523b provided to be connected parallel to the first to fourth inlet valves 1511a, 1511b, 1521a, and 1521b. The check valves 1513a, 1513b, 1523a, and 1523b may be provided on bypass flow paths connecting front and rear ends of the first to fourth inlet valves 1511a, 1511b, 1521a, and 1521b on the first and second hydraulic circuits 1510 and 1520 and may allow only the flow of the pressurizing medium from each wheel cylinder 20 toward the hydraulic pressure supply device 1300 and block the flow of the pressurizing medium from the hydraulic pressure supply device 1300 to the wheel cylinder 20. Due to the first to fourth check valves 1513a, 1513b, 1523a, and 1523b, the hydraulic pressure of the pressurizing medium applied to each wheel cylinder 20 may be quickly discharged, and even when the first to fourth inlet valves 1511a, 1511b, 1521a, and 1521b do not normally operate, the hydraulic pressure of the pressurizing medium applied to the wheel cylinder 20 may be smoothly returned to the hydraulic pressure supply device 1300.

The first and second hydraulic circuits 1510 and 1520 may include first to fourth outlet valves 1512a, 1512b, 1522a, and 1522b for controlling the flow of the pressurizing media discharged from the first to fourth wheel cylinders 21, 22, 23, and 24 to the reservoir 1100 in order to improve performance when the braking of the wheel cylinder 20 is released. The first and second outlet valves 1512a and 1512b are respectively provided at discharge sides of the first and second wheel cylinders 21 and 22 to control the flow of the pressurizing media transmitted from the first and second wheel cylinders 21 and 22 to the second reservoir chamber 1100b of the reservoir 1100. To this end, downstream sides of the first and second outlet valves 1512a and 1512b and the second reservoir chamber 1100b may be connected by the first discharge flow path 1610. Likewise, the third and fourth outlet valves 1522a and 1522b are respectively provided at discharge sides of the third and fourth wheel cylinders 23 and 24 to control the flow of the pressurizing media transmitted from the third and fourth wheel cylinders 23 and 24 to the third reservoir chamber 1100c of the reservoir 1100. To this end, downstream sides of the third and fourth outlet valves 1522a and 1522b and the third reservoir chamber 1100c may be connected by the second discharge flow path 1620. The first to fourth outlet valves 1512a, 1512b, 1522a, and 1522b may selectively release the hydraulic pressure of the pressurizing medium applied to the wheel cylinder in which a braking force needs to be released for a stable behavior of a vehicle, such as an anti-lock brake system (ABS) braking mode of a vehicle, and transmit the hydraulic pressure of the pressurizing medium to the reservoir 1100.

Meanwhile, when the hydraulic pressure supply device 1300 may not normally operate due to a failure of the hydraulic pressure supply device 1300, the hydraulic pressure of the pressurizing medium applied to the wheel cylinder 20 needs to be removed to prevent an accident such as a rear-end collision of a following vehicle. Therefore, the first to fourth outlet valves 1512a, 1512b, 1522a, and 1522b may each be provided as a normal open type solenoid valve that is normally open and then operated so that the valve is closed upon receiving an electrical signal from an auxiliary ECU. Therefore, since the first to fourth outlet valves 1512a, 1512b, 1522a, and 1522b are in open states when the hydraulic pressure providing unit 1000B including the hydraulic pressure supply device 1300 is inoperable, the hydraulic pressures of the pressurizing media applied to the first to fourth wheel cylinders 21, 22, 23, and 24 may be discharged to the reservoir 1100, thereby preventing an accident such as a rear-end collision.

The hydraulic pressure providing unit 1000B may include a first circuit pressure sensor PS1 for detecting the hydraulic pressure of the pressurizing medium transmitted to the first hydraulic circuit 1510 and a second hydraulic pressure sensor PS2 for detecting the hydraulic pressure of the pressurizing medium transmitted to the second hydraulic circuit 1520.

The first circuit pressure sensor PS1 may detect the hydraulic pressure of the pressurizing medium generated and provided from the hydraulic pressure supply device 1300 and transmitted to the first hydraulic circuit 1510 and transmit pressure numerical information to the first ECU ECU1. In addition, the second circuit pressure sensor PS2 may detect the hydraulic pressure of the pressurizing medium generated and provided from the hydraulic pressure supply device 1300 and transmitted to the second hydraulic circuit 1520 and transmit pressure numerical information to the first ECU ECU1. The first ECU ECU1 may receive hydraulic pressure value information of each hydraulic circuit from the first and second circuit pressure sensors PS1 and PS2 to control the operations of the hydraulic pressure supply device 1300 and the hydraulic pressure control device 1400 based on the hydraulic pressure numerical information, thereby assisting autonomous traveling of a vehicle, such as highway driving assist or emergency braking of a vehicle.

Hereinafter, a method of operating the electronic brake system 1000 according to the first embodiment of the present invention will be described.

In a normal operation mode of the electronic brake system 1000 according to the first embodiment of the present invention, as the hydraulic pressure transmitted from the hydraulic pressure supply device 1300 to the wheel cylinder 20 increases, a first braking mode to a third braking mode may be separately operated. Specifically, in the first braking mode, the hydraulic pressure may be primarily provided to the wheel cylinder 20 by the hydraulic pressure supply device 1300, in the second braking mode, the hydraulic pressure may be secondarily provided to the wheel cylinder 20 by the hydraulic pressure supply device 1300 to transmit a braking pressure higher than the braking pressure in the first braking mode, and, in the third braking mode, the hydraulic pressure may be tertiarily provided to the wheel cylinder by the hydraulic pressure supply device 1300 to transmit a braking pressure higher than the braking pressure in the second braking mode.

The first braking mode to the third braking mode may be switched by differently performing the operations of the hydraulic pressure supply device 1300 and the hydraulic pressure control device 1400. The hydraulic pressure supply device 1300 can provide a sufficient high hydraulic pressure of a pressurizing medium even without a high-end motor using the first to third braking modes and also prevent an unnecessary load applied to the motor. Therefore, it is possible to secure a stable braking force while reducing the costs and weight of the brake system and improve durability and operational reliability of the device.

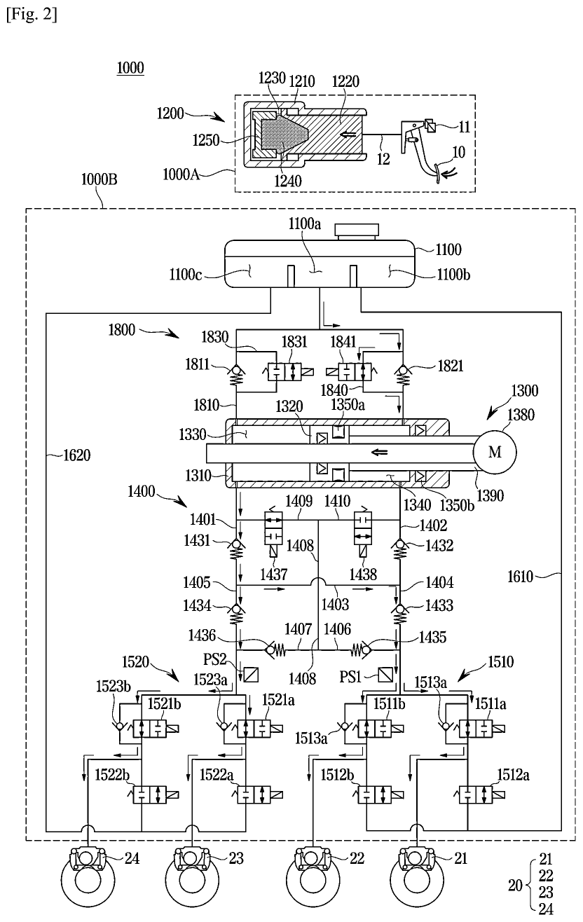

FIG. 2 is a hydraulic circuit diagram illustrating a state in which the electronic brake system 1000 according to the first embodiment of the present invention performs a first braking mode.

Referring to FIG. 2, when the driver steps on the brake pedal 10 at the beginning of braking, since the main motor 1380 operates to rotate in one direction and the hydraulic piston 1320 moves forward by the rotating force of the main motor 1380 transmitted to the hydraulic piston 1320 by the power converter to generate the hydraulic pressure in the first pressure chamber 1330. The hydraulic pressure discharged from the first pressure chamber 1330 is transmitted to each wheel cylinder 20 after passing the hydraulic pressure control device 1400, the first hydraulic circuit 1510, and the second hydraulic circuit 1520 to generate the braking force.

Specifically, the hydraulic pressure of the pressurizing medium generated in the first pressure chamber 1330 is primarily transmitted to the first and second wheel cylinders 21 and 22 provided in the first hydraulic circuit 1510 after sequentially passing the first hydraulic flow path 1401, the third hydraulic flow path 1403, and the fourth hydraulic flow path 1404. At this time, since the first valve 1431 is provided as a check valve for allowing only the flow of the pressurizing medium discharged from the first pressure chamber 1330 and the third valve 1433 is provided as a check valve for allowing the pressurizing medium to flow only from the third hydraulic flow path 1403 toward the first hydraulic circuit 1510, the hydraulic pressure of the pressurizing medium may be smoothly transmitted to the first and second wheel cylinders 21 and 22. In addition, the first inlet valve 1511a and the second inlet valve 1511b provided in the first hydraulic circuit 1510 may maintain the open states, and the first and second outlet valves 1512a and 1512b may be switched to the closed states, thereby preventing the hydraulic pressure of the pressurizing medium from leaking to the first discharge flow path 1610.

In addition, the hydraulic pressure generated in the first pressure chamber 1330 is primarily transmitted to the third and fourth wheel cylinders 23 and 24 provided in the second hydraulic circuit 1520 after sequentially passing the first hydraulic flow path 1401 and the fifth hydraulic flow path 1405. As described above, since the first valve 1431 is provided as a check valve for allowing only the flow of the pressurizing medium discharged from the first pressure chamber 1330 and the fourth valve 1434 is provided as a check valve for allowing the pressurizing medium to flow only from the third hydraulic flow path 1403 toward the second hydraulic circuit 1520, the hydraulic pressure of the pressurizing medium may be smoothly transmitted to the third and fourth wheel cylinders 23 and 24. In addition, the third inlet valve 1521a and the fourth inlet valve 1521b provided in the second hydraulic circuit 1520 may maintain the open states, and the third outlet valve 1522a and the fourth outlet valve 1522b may be switched to the closed states, thereby preventing the hydraulic pressure of the pressurizing medium from leaking to the second discharge flow path 1620.

In the first braking mode, the eighth valve 1438 may be controlled to the closed state, thereby preventing the hydraulic pressure of the pressurizing medium generated in the first pressure chamber 1330 from leaking to the second pressure chamber 1340. In addition, the first dump valve 1831 provided on the first bypass flow path 1830 may maintain the closed state, thereby preventing the hydraulic pressure generated in the first pressure chamber 1330 from leaking to the reservoir 1100.

Meanwhile, the negative pressure may be generated in the second pressure chamber 1340 due to the forward movement of the hydraulic piston 1320, and the hydraulic pressure of the pressurizing medium may be transmitted from the reservoir 1100 to the second pressure chamber 1340 through the second dump flow path 1820 to prepare the second braking mode to be described below. The second dump check valve 1821 provided on the second dump flow path 1820 allows the pressurizing medium to flow from the reservoir 1100 toward the second pressure chamber 1340 to stably supply the pressurizing medium to the second pressure chamber 1340, and the second dump valve 1841 provided on the second bypass flow path 1840 may be switched to the open state to quickly supply the pressurizing medium from the reservoir 1100 to the first pressure chamber 1330.

At this time, as the operation of the brake pedal 10 is performed by the driver's pedal force, the simulation piston 1220 moves forward to compress the elastic member 1240, and the elastic restoring force of the elastic member 1240 may be provided to the driver as a pedal feel.

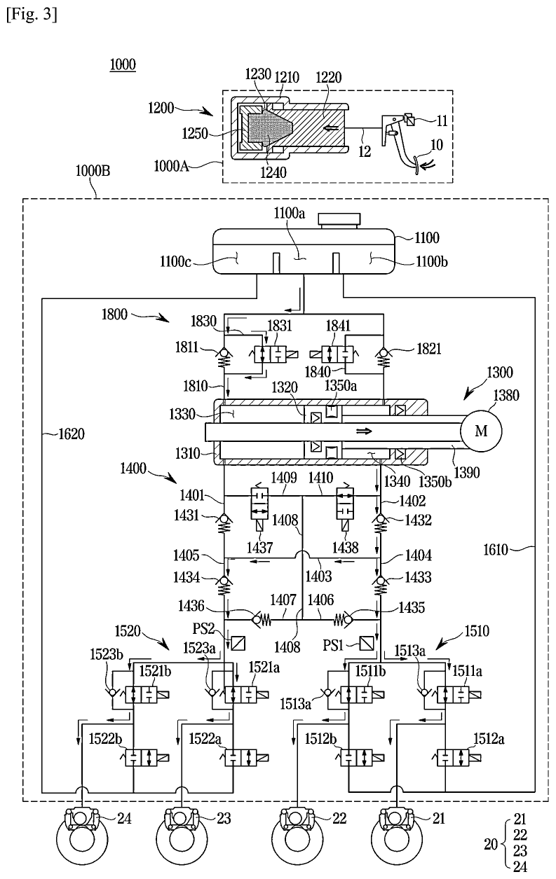

The electronic brake system 1000 according to the first embodiment of the present invention may switch the operation mode from the first braking mode to the second braking mode illustrated in FIG. 3 when a higher braking pressure than in the first braking mode needs to be provided.

FIG. 3 is a hydraulic circuit diagram illustrating a state in which the electronic brake system 1000 according to the first embodiment of the present invention performs a second braking mode, and referring to FIG. 3, the first ECU may determine that a higher braking pressure is required when the displacement of the brake pedal 10 detected by the pedal displacement sensor 11 or an operation speed of the brake pedal 10 is higher than a preset level and switch the operation mode from the first braking mode to the second braking mode.

When the operation mode is switched from the first braking mode to the second braking mode, the main motor 1380 operates to rotate in the other direction, and the hydraulic piston 1320 moves backward by the rotating force of the motor transmitted to the hydraulic piston 1320 by the power converter to generate the hydraulic pressure in the second pressure chamber 1340. The hydraulic pressure discharged from the second pressure chamber 1340 is transmitted to each wheel cylinder 20 after passing the hydraulic pressure control device 1400, the first hydraulic circuit 1510, and the second hydraulic circuit 1520 to generate the braking force.

Specifically, the hydraulic pressure generated in the second pressure chamber 1340 is secondarily transmitted to the first and second wheel cylinders 21 and 22 provided in the first hydraulic circuit 1510 after sequentially passing the second hydraulic flow path 1402 and the fourth hydraulic flow path 1404. At this time, since the second valve 1432 provided on the second hydraulic flow path 1402 is provided as a check valve for allowing only the flow of the pressurizing medium discharged from the second pressure chamber 1340 and the third valve 1433 provided on the fourth hydraulic flow path 1404 is provided as a check valve for allowing the pressurizing medium to flow only from the third hydraulic flow path 1403 toward the first hydraulic circuit 1510, the hydraulic pressure of the pressurizing medium may be smoothly transmitted to the first and second wheel cylinders 21 and 22. The first inlet valve 1511a and the second inlet valve 1511b provided in the first hydraulic circuit 1510 may maintain the open states, and the first and second outlet valves 1512a and 1512b may be switched to the closed states, thereby preventing the hydraulic pressure of the pressurizing medium from leaking to the first discharge flow path 1610.

In addition, the hydraulic pressure generated in the second pressure chamber 1340 is secondarily transmitted to the third and fourth wheel cylinders 23 and 24 provided in the second hydraulic circuit 1520 after sequentially passing the second hydraulic flow path 1402, the third hydraulic flow path 1403, and the fifth hydraulic flow path 1405. As described above, since the second valve 1432 provided on the second hydraulic flow path 1402 is provided as a check valve for allowing only the flow of the pressurizing medium discharged from the second pressure chamber 1340 and the fourth valve 1434 provided on the fifth hydraulic flow path 1405 is provided as a check valve for allowing the pressurizing medium to flow only from the third hydraulic flow path 1403 toward the second hydraulic circuit 1520, the hydraulic pressure of the pressurizing medium may be smoothly transmitted to the third and fourth wheel cylinders 23 and 24. In addition, the third inlet valve 1521a and the fourth inlet valve 1521b provided in the second hydraulic circuit 1520 may maintain the open states, and the third outlet valve 1522a and the fourth outlet valve 1522b may be switched to the closed states, thereby preventing the hydraulic pressure of the pressurizing medium from leaking to the second discharge flow path 1620.

In the second braking mode, the seventh valve 1437 may be controlled to be in the closed state, thereby preventing the hydraulic pressure of the pressurizing medium generated in the second pressure chamber 1340 from leaking to the first pressure chamber 1330. In addition, the second dump valve 1841 may be switched to the closed state, thereby preventing the hydraulic pressure of the pressurizing medium generated in the second pressure chamber 1340 from leaking to the reservoir 1100.

Meanwhile, the negative pressure may be generated in the first pressure chamber 1330 due to the backward movement of the hydraulic piston 1320, and the hydraulic pressure of the pressurizing medium may be transmitted from the reservoir 1100 to the first pressure chamber 1330 through the first dump flow path 1810 to prepare the third braking mode to be described below. Since the first dump check valve 1811 provided on the first dump flow path 1810 allows the pressurizing medium to flow from the reservoir 1100 toward the first pressure chamber 1330, the pressurizing medium may be stably supplied to the first pressure chamber 1330, and the first dump valve 1831 provided on the first bypass flow path 1830 may be switched to the open state to quickly supply the pressurizing medium from the reservoir 1100 to the first pressure chamber 1330.

An operation of the pedal simulator 1200 in the second braking mode is the same as the above-described operation of the pedal simulator 1200 in the first braking mode of the electronic brake system, and a description thereof will be omitted to prevent an overlapping description.

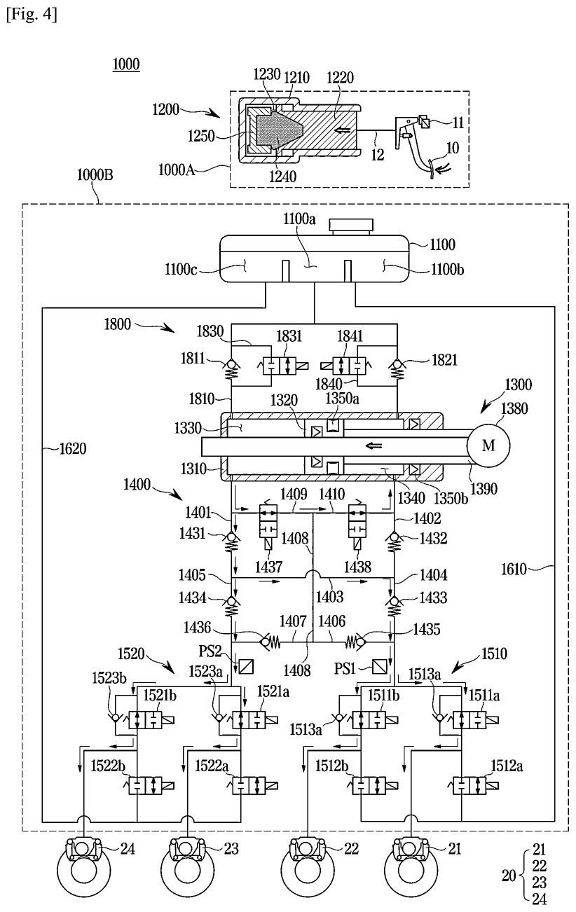

The electronic brake system 1000 according to the first embodiment of the present invention may switch the operation mode from the second braking mode to the third braking mode illustrated in FIG. 4 when a higher braking pressure than the braking pressure in the second braking mode needs to be provided.

FIG. 4 is a hydraulic circuit diagram illustrating a state in which the electronic brake system 1000 according to the first embodiment of the present invention performs a third braking mode. Referring to FIG. 4, the first ECU may determine that a higher braking pressure is required when the displacement of the brake pedal 10 detected by the pedal displacement sensor 11 or the operation speed of the brake pedal 10 is higher than a preset level and switch the operation mode from the second braking mode to the third braking mode.

When the operation mode is switched from the second braking mode to the third braking mode, the main motor 1380 operates to rotate in one direction, and the hydraulic piston 1320 moves forward again by the rotating force of the motor transmitted to the hydraulic piston 1320 by the power converter to generate the hydraulic pressure in the first pressure chamber 1330. The hydraulic pressure discharged from the first pressure chamber 1330 is transmitted to each wheel cylinder 20 after passing the hydraulic pressure control device 1400, the first hydraulic circuit 1510, and the second hydraulic circuit 1520 to generate the braking force.

Specifically, a part of the hydraulic pressure generated in the first pressure chamber 1330 is tertiarily transmitted to the first and second wheel cylinders 21 and 22 provided in the first hydraulic circuit 1510 after sequentially passing the first hydraulic flow path 1401, the third hydraulic flow path 1403, and the fourth hydraulic flow path 1404. At this time, since the first valve 1431 is provided as a check valve for allowing only the flow of the pressurizing medium discharged from the first pressure chamber 1330 and the third valve 1433 is provided as a check valve for allowing the pressurizing medium to flow only from the third hydraulic flow path 1403 toward the first hydraulic circuit 1510, the hydraulic pressure of the pressurizing medium may be smoothly transmitted to the first and second wheel cylinders 21 and 22. In addition, the first inlet valve 1511a and the second inlet valve 1511b provided in the first hydraulic circuit 1510 may maintain the open states, and the first and second outlet valves 1512a and 1512b may be switched to the closed states, thereby preventing the hydraulic pressure of the pressurizing medium from leaking to the first discharge flow path 1610.

In addition, a part of the hydraulic pressure generated in the first pressure chamber 1330 is tertiarily transmitted to the third and fourth wheel cylinders 23 and 24 provided in the second hydraulic circuit 1520 after sequentially passing the first hydraulic flow path 1401 and the fifth hydraulic flow path 1405. As described above, since the first valve 1431 is provided as a check valve for allowing only the flow of the pressurizing medium discharged from the first pressure chamber 1330 and the fourth valve 1434 is provided as a check valve for allowing the pressurizing medium to flow only from the third hydraulic flow path 1403 toward the second hydraulic circuit 1520, the hydraulic pressure of the pressurizing medium may be smoothly transmitted to the third and fourth wheel cylinders 23 and 24. In addition, the third inlet valve 1521a and the fourth inlet valve 1521b provided in the second hydraulic circuit 1520 may maintain the open states, and the third outlet valve 1522a and the fourth outlet valve 1522b may be switched to the closed states, thereby preventing the hydraulic pressure of the pressurizing medium from leaking to the second discharge flow path 1620.

Meanwhile, since the third braking mode is a state in which the high hydraulic pressure is provided, as the hydraulic piston 1320 moves forward, a force of the hydraulic pressure in the first pressure chamber 1330 making the hydraulic piston to move backward also increases, and thus a load applied to the motor rapidly increases. Therefore, in the third braking mode, the seventh valve 1437 and the eighth valve 1438 are opened to allow the flow of the pressurizing medium through the ninth hydraulic flow path 1409 and the tenth hydraulic flow path 1410. That is, a part of the hydraulic pressure generated in the first pressure chamber 1330 may be supplied to the second pressure chamber 1340 after sequentially passing the ninth hydraulic flow path 1409 and the tenth hydraulic flow path 1410, and thus the first pressure chamber 1330 and the second pressure chamber 1340 may communicate with each other to synchronize the hydraulic pressures, thereby reducing the load applied to the motor and improving durability and reliability of the device. In the third braking mode, the first dump valve 1831 may be switched to the closed state, thereby preventing the hydraulic pressure of the pressurizing medium generated in the first pressure chamber 1330 from leaking to the reservoir 1100 along the first bypass flow path 1830, and the second dump valve 1841 may be also controlled to the closed state to quickly generate the negative pressure in the second pressure chamber 1340 by the forward movement of the hydraulic piston 1320 and smoothly receive the pressurizing medium provided from the first pressure chamber 1330.

An operation of the pedal simulator 1200 in the third braking mode is the same as the above-described operations of the pedal simulator 1200 in the first and second braking modes of the electronic brake system, and a description thereof will be omitted to prevent an overlapping description.

Hereinafter, a method of operating an electronic brake system 2000 according to a second embodiment of the present invention will be described.

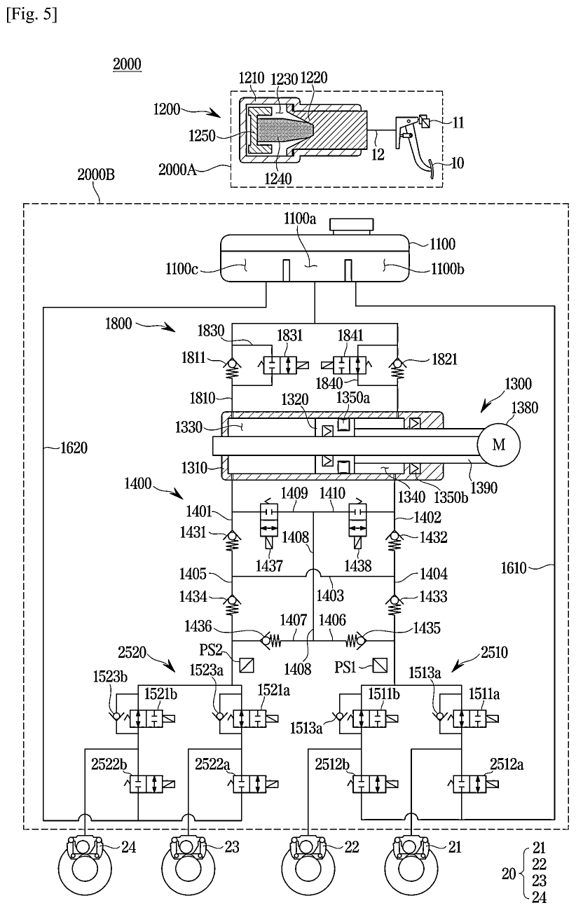

FIG. 5 is a hydraulic circuit diagram illustrating the electronic brake system 2000 according to the second embodiment of the present invention, and referring to FIG. 5, first and second hydraulic circuits 2510 and 2520 of the electronic brake system 2000 according to the second embodiment may include first to fourth outlet valves 2512a, 2512b, 2522a, and 2522b for respectively controlling the flow of the pressurizing media discharged from the first to fourth wheel cylinders 21, 22, 23, and 24 to the reservoir 1100 in order to improve performance when the braking of the wheel cylinder 20 is released.

Since a description of the electronic brake system 2000 according to the second embodiment of the present invention, which will be given below, is the same as the above description of the electronic brake system 1000 according to the first embodiment of the present invention other than a case in which an additional description is made by denoting the reference numerals, the description will be omitted to prevent an overlapping description.

The first and second outlet valves 2512a and 2512b are respectively provided at the discharge sides of the first and second wheel cylinders 21 and 22 to control the flow of the pressurizing media transmitted from the first and second wheel cylinders 21 and 22 to the second reservoir chamber 1100b of the reservoir 1100. To this end, downstream sides of the first and second outlet valves 2512a and 2512b and the second reservoir chamber 1100b may be connected by the first discharge flow path 1610. Likewise, the third and fourth outlet valves 2522a and 2522b are respectively provided at the discharge sides of the third and fourth wheel cylinders 23 and 24 to control the flow of the pressurizing media transmitted from the third and fourth wheel cylinders 23 and 24 to the third reservoir chamber 1100c of the reservoir 1100. To this end, downstream sides of the third and fourth outlet valves 2522a and 2522b and the third reservoir chamber 1100c may be connected by the second discharge flow path 1620. The first to fourth outlet valves 2512a, 2512b, 2522a, and 2522b may selectively release the hydraulic pressure of the pressurizing medium applied to the wheel cylinder in which a braking force needs to be released for a stable behavior of a vehicle, such as an ABS braking mode of a vehicle, and transmit the hydraulic pressure of the pressurizing medium to the reservoir 1100.

Meanwhile, today, as various electronic devices are installed in a vehicle and electric vehicles for receiving a power from a power supplier such as a battery and using the power as an operation power of the vehicle are popularized, power efficiency of the vehicle is becoming a major purchase factor. The first to fourth outlet valves 2512a, 2512b, 2522a, and 2522b maintain closed states for a long time during the vehicle operation other than special cases such as an ABS braking mode. Therefore, in order to improve the power efficiency of the vehicle by minimizing the electrical signals and the powers supplied to the first to fourth outlet valves 2512a, 2512b, 2522a, and 2522b, the first to fourth outlet valves 2512a, 2512b, 2522a, and 2522b may each be provided as a normal closed type solenoid valve that is normally closed and then operated so that the valve is opened upon receiving an electrical signal from an auxiliary ECU.

Hereinafter, a method of operating an electronic brake system 3000 according to a third embodiment of the present invention will be described.

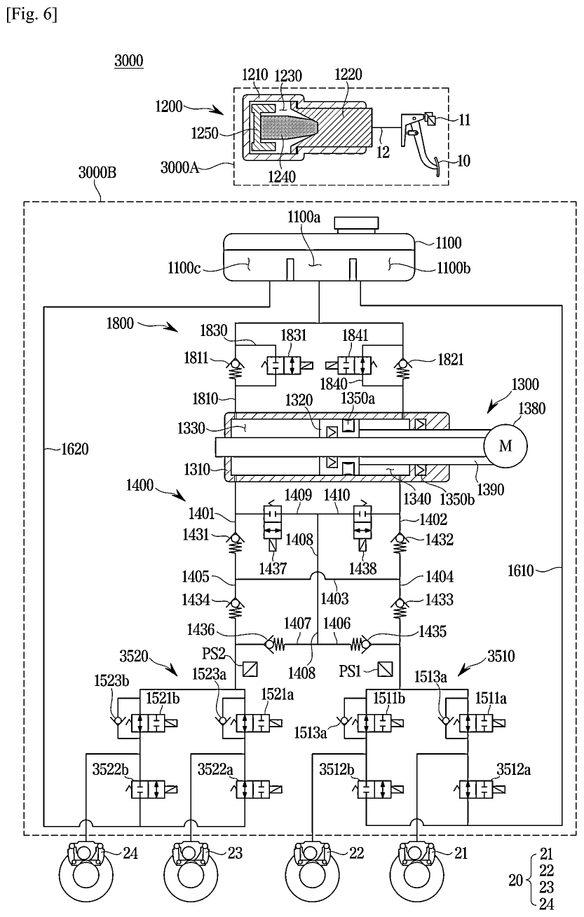

FIG. 6 is a hydraulic circuit diagram illustrating the electronic brake system 3000 according to the third embodiment of the present invention, and referring to FIG. 6, first and second hydraulic circuits 3510 and 3520 of the electronic brake system 3000 according to the third embodiment may include first to fourth outlet valves 3512a, 3512b, 3522a, and 3522b for respectively controlling the flow of the pressurizing media discharged from the first to fourth wheel cylinders 21, 22, 23, and 24 to the reservoir 1100 in order to improve performance when the braking of the wheel cylinder 20 is released.

Since a description of the electronic brake system 3000 according to the third embodiment of the present invention, which will be given below, is the same as the above description of the electronic brake system 1000 and 2000 according to the first and second embodiments of the present invention other than a case in which an additional description is made by denoting the reference numerals, the description will be omitted to prevent an overlapping description.

The first and second outlet valves 3512a and 3512b are respectively provided at the discharge sides of the first and second wheel cylinders 21 and 22 to control the flow of the pressurizing media transmitted from the first and second wheel cylinders 21 and 22 to the second reservoir chamber 1100b of the reservoir 1100. To this end, downstream sides of the first and second outlet valves 3512a and 3512b and the second reservoir chamber 1100b may be connected by the first discharge flow path 1610. Likewise, the third and fourth outlet valves 3522a and 3522b are respectively provided at the discharge sides of the third and fourth wheel cylinders 23 and 24 to control the flow of the pressurizing media transmitted from the third and fourth wheel cylinders 23 and 24 to the third reservoir chamber 1100c of the reservoir 1100. To this end, downstream sides of the third and fourth outlet valves 3522a and 3522b and the third reservoir chamber 1100c may be connected by the second discharge flow path 1620. The first to fourth outlet valves 3512a, 3512b, 3522a, and 3522b may selectively release the hydraulic pressure of the pressurizing medium applied to the wheel cylinder in which a braking force needs to be released for a stable behavior of a vehicle, such as an ABS braking mode of a vehicle, and transmit the hydraulic pressure of the pressurizing medium to the reservoir 1100.

As described above, when the hydraulic pressure supply device 1300 may not normally operate due to a failure of the hydraulic pressure supply device 1300 or the like, the hydraulic pressure of the pressurizing medium applied to the wheel cylinder 20 needs to be removed to prevent an accident such as a rear-end collision of a following vehicle. At the same time, the power efficiency of the vehicle also needs to be improved. Therefore, any one of the first and second outlet valves 3512a and 3512b may be provided as a normal open type solenoid valve that is normally open and then operated so that the valve is closed upon receiving an electrical signal from an auxiliary ECU, and the other may be provided as a normal closed type solenoid valve that is normally in a closed state and then operated so that the valve is opened upon receiving an electrical signal from an auxiliary ECU. For example, as illustrated in FIG. 6, the first outlet valve 3512a may be provided as the normal open type solenoid valve, and the second outlet valve 3512b may be provided as the normal closed type solenoid valve.

Likewise, any one of the third and fourth outlet valves 3522a and 3522b may be provided as a normal open type solenoid valve that is normally open and then operated so that the valve is closed upon receiving an electrical signal from an auxiliary ECU, and the other may be provided as a normal closed type solenoid valve that is normally in a closed state and then operated so that the valve is opened upon receiving an electrical signal from an auxiliary ECU. For example, the third outlet valve 3522a may be provided as the normal open type solenoid valve, and the fourth outlet valve 3522b may be provided as the normal closed type solenoid valve.

Therefore, the second and fourth outlet valves 3512b and 3522b may maintain the closed states for a long time during the vehicle operation other than special cases, thereby improving the power efficiency of the vehicle, and when the hydraulic pressure providing unit 1000B including the hydraulic pressure supply device 1300 is inoperable, the first and third outlet valves 3512a and 3522a are in the open states, and thus the hydraulic pressures of the pressurizing media applied to the first to fourth wheel cylinders 21, 22, 23, and 24 may be discharged to the reservoir 1100 after passing the first and second discharge flow paths 1610 and 1620 by the first and third output valves 3512a and 3522a, thereby preventing an accident such as a rear-end collision.

Hereinafter, a method of operating an electronic brake system 4000 according to a fourth embodiment of the present invention will be described.

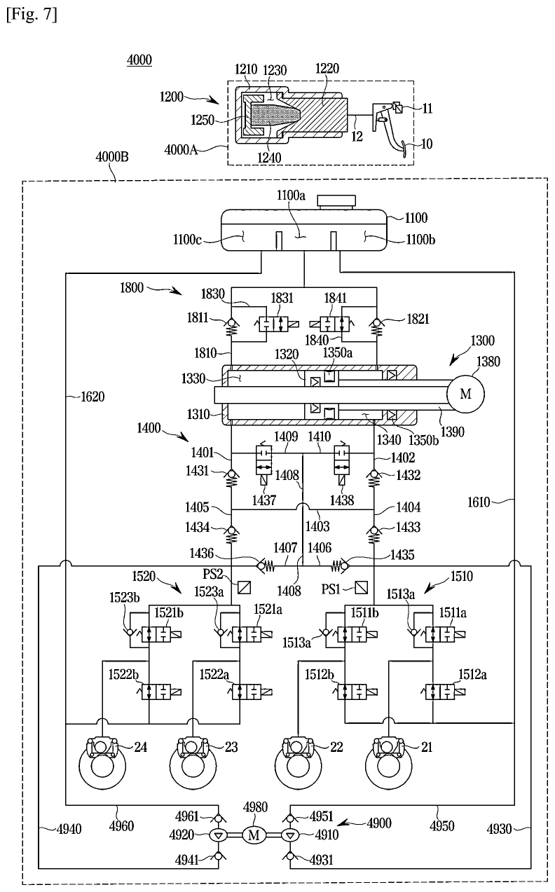

FIG. 7 is a hydraulic circuit diagram illustrating the electronic brake system 4000 according to the fourth embodiment of the present invention, and referring to FIG. 7, a hydraulic pressure providing unit 4000B of the electronic brake system 4000 according to the fourth embodiment further includes a hydraulic pressure auxiliary device 4900 for auxiliarily providing the hydraulic pressure of the pressurizing medium when the hydraulic pressure supply device 1300 is inoperable, and a second ECU ECU2 (not illustrated) for controlling an operation of the hydraulic pressure auxiliary device 4900.

Since a description of the electronic brake system 4000 according to the fourth embodiment of the present invention, which will be given below, is the same as the above description of the electronic brake system 1000 according to the first embodiment of the present invention excluding a case in which an additional description is made by denoting the reference numerals, the description will be omitted to prevent an overlapping description.

The hydraulic pressure auxiliary device 4900 may operate when the hydraulic pressure supply device 1300 is inoperable due to a failure of the hydraulic pressure supply device 1300 or the like so as to generate and provide hydraulic pressures required for emergency braking of the first to fourth wheel cylinders 21, 22, 23, and 24. In the present embodiment, a mode in which the hydraulic pressure auxiliary device 4900 operates due to the inoperability of the hydraulic pressure supply device 1300 is referred to as “emergency braking mode.”

The hydraulic pressure auxiliary device 4900 includes first and second hydraulic pumps 4910 and 4920 for generating auxiliary hydraulic pressures of the pressurizing medium, a backup motor 4980 for driving the pair of hydraulic pumps 4910 and 4920, a first auxiliary hydraulic flow path 4930 for transmitting the pressurizing medium pressurized by the first hydraulic pump 4910 to the first hydraulic circuit 1510, a second auxiliary hydraulic flow path 4940 for transmitting the pressurizing medium pressurized by the second hydraulic pump 4920 to the second hydraulic circuit 1520, a first auxiliary discharge flow path 4950 for introducing the pressurizing medium discharged from the first hydraulic circuit 1510 into the first hydraulic pump 4910, and a second auxiliary discharge flow path 4960 for introducing the pressurizing medium discharged from the second hydraulic circuit 1520 into the second hydraulic pump 4920.

The first ECU ECU1 or the second ECU ECU2 switches the operation mode to the emergency braking mode to operate the backup motor 4980 when determining that the hydraulic pressure supply device 1300 is inoperable, such as a failure of the hydraulic pressure supply device 1300, or when determining that operation control of the hydraulic pressure supply device 1300 is impossible. The backup motor 4980 may be operated by receiving the driver's braking intention as the electrical signal from the pedal displacement sensor 11 for detecting the displacement of the brake pedal 10. The backup motor 4980 may operate the pair of hydraulic pumps 4910 and 4920 after receiving a power from a battery or the like.

The pair of hydraulic pumps 4910 and 4920 may pressurize the pressurizing medium due to the reciprocating movement of a piston (not illustrated) provided in the backup motor 4980. Specifically, the first hydraulic pump 4910 may receive the pressurizing medium from the first auxiliary discharge flow path 4950 connected to a suction end thereof to generate the hydraulic pressure of the pressurizing medium required for braking the first hydraulic circuit 1510, and the second hydraulic pump 4920 may receive the pressurizing medium from the second auxiliary discharge flow path 4960 connected to a suction end thereof to generate the hydraulic pressure of the pressurizing medium required for braking the second hydraulic circuit 1520. To this end, an inlet end of the first auxiliary discharge flow path 4950 may be connected to the downstream sides of the first and second outlet valves 1512a and 1512b, and an outlet end thereof may be connected to the suction end of the first hydraulic pump 4910. A check valve 4951 may be provided on the first auxiliary discharge flow path 4950 to allow only the flow of the pressurizing medium from the first hydraulic circuit 1510 toward the suction end of the first hydraulic pump 4910 and block the flow of the pressurizing medium in a reverse direction, thereby preventing a backflow of the pressurizing medium. Likewise, an inlet end of the second auxiliary discharge flow path 4960 may be connected to the downstream sides of the third and fourth outlet valves 1522a and 1522b, an outlet end thereof may be connected to the suction end of the second hydraulic pump 4920, and a check valve 4961 may be provided on the second auxiliary discharge flow path 4960 to allow only the flow of the pressurizing medium from the second hydraulic circuit 1520 toward the suction end of the second hydraulic pump 4920.

The pressurizing medium whose hydraulic pressure has been generated by the first hydraulic pump 4910 may be provided to the first hydraulic circuit 1510 through the first auxiliary hydraulic flow path 4930. Specifically, an inlet end of the first auxiliary hydraulic flow path 4930 may be connected to a discharge end of the first hydraulic pump 4910, an outlet end thereof may be connected to the upstream sides of the first and second inlet valves 1511a and 1511b on the first hydraulic circuit 1510, and the first auxiliary hydraulic flow path 4930 may be provided with a check valve 4931 to transmit the pressurized pressurizing medium transmitted from the first hydraulic pump 4910 to the first hydraulic circuit 1510 to perform the braking of the first and second wheel cylinders 21 and 22.

The pressurizing medium whose hydraulic pressure has been generated by the second hydraulic pump 4920 may be provided to the second hydraulic circuit 1520 through the second auxiliary hydraulic flow path 4940. To this end, an inlet end of the second auxiliary hydraulic flow path 4940 may be connected to a discharge end of the second hydraulic pump 4920, an outlet end thereof may be connected to the upstream sides of the third and fourth inlet valves 1521a and 1521b on the second hydraulic circuit 1520, and the second auxiliary hydraulic flow path 4940 may be provided with a check valve 4941 to transmit the pressurized pressurizing medium transmitted from the second hydraulic pump 4920 to the second hydraulic circuit 1520 to perform the braking of the third and fourth wheel cylinders 23 and 24.

The operation of the hydraulic pressure auxiliary device 4900 may be controlled by the second ECU ECU2 provided independently of the first ECU ECU1. The second ECU ECU2 may be provided to transmit an electrical signal separately from the signal of the first ECU ECU1 to perform the emergency braking of the vehicle by stably operating and controlling the hydraulic pressure auxiliary device 4900 even when the first ECU ECU1 is inoperable. In addition, the second ECU ECU2 may be provided to receive a power separately from the power of the first ECU ECU1.

Hereinafter, the emergency braking mode of the electronic brake system 4000 according to the fourth embodiment of the present invention will be described.

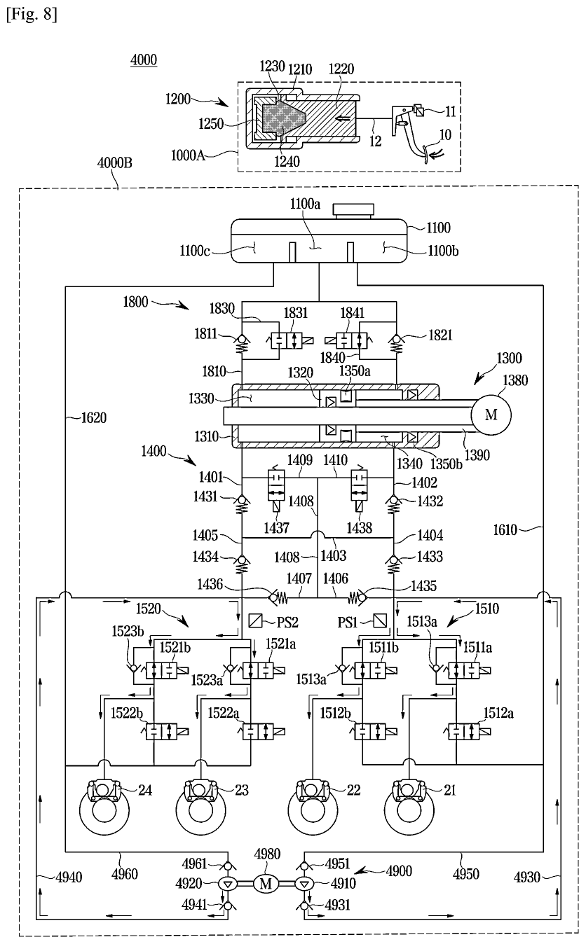

The electronic brake system 4000 according to the fourth embodiment of the present invention may switch the operation mode to an emergency operation mode illustrated in FIG. 8 when the hydraulic pressure supply device 1300 corresponds to an inoperable state such as a failure or a leakage of the pressurizing medium.

FIG. 8 is a hydraulic circuit diagram illustrating a state in which the electronic brake system 400 according to the fourth embodiment of the present invention performs the emergency braking mode, and referring to FIG. 8, when a driver applies a pedal force to the brake pedal 10 in the emergency braking mode, the second ECU ECU2 operates the hydraulic pressure auxiliary device 4900 based on the displacement information of the brake pedal 10 detected by the pedal displacement sensor 11.

The second ECU ECU2 operates the backup motor 4980 based on the displacement information of the brake pedal 10 detected by the pedal displacement sensor 11 to operate the first and second hydraulic pumps 4910 and 4920. The first hydraulic pump 4910 may generate the hydraulic pressure of the pressurizing medium, and the pressurizing medium whose hydraulic pressure has been generated may be supplied to the first hydraulic circuit 1510 after passing the first auxiliary hydraulic flow path 4930. The pressurizing medium supplied to the first hydraulic circuit 1510 may be transmitted to the first and second wheel cylinders 21 and 22 to perform emergency braking. Likewise, the second hydraulic pump 4920 may generate the hydraulic pressure of the pressurizing medium, and the pressurizing medium whose hydraulic pressure has been generated may be supplied to the second hydraulic circuit 1520 after passing the second auxiliary hydraulic flow path 4940. The pressurizing medium supplied to the second hydraulic circuit 1520 may be transmitted to the third and fourth wheel cylinders 23 and 24 to perform the emergency braking.

Describing the release of the braking in the emergency braking mode, the second ECU ECU2 may stop the operation of the backup motor 4980, and the pressurizing media applied to the first and second wheel cylinders 21 and 22 may be introduced into the first auxiliary discharge flow path 4950 after passing the first and second outlet valves 1511a and 1511b and discharged to the suction end of the first hydraulic pump 4910. In addition, the pressurizing media applied to the third and fourth wheel cylinders 23 and 24 may be introduced into the second auxiliary discharge flow path 4960 after passing the third and fourth outlet valves 1521a and 1521b and discharged to the suction end of the second hydraulic pump 4920.

As described above, although the present invention has been described with the limited embodiments and drawings, the present invention is not limited thereto, and it goes without saying that various modifications and changes are possible by those skilled in the art to which the present invention pertains without departing from the technical spirit of the present invention and the equivalent scope of the appended claims.

1. An electronic brake system comprising:
a pedal unit connected to a brake pedal and operated by a driver's pedal force; and
a hydraulic pressure providing unit configured to generate a hydraulic pressure of a pressurizing medium for braking a vehicle based on an electrical signal output in response to displacement of the brake pedal,
wherein the pedal unit includes a pedal simulator configured to generate a reaction force to a pedal force of the brake pedal and provide a pedal feel to the driver,
the hydraulic pressure providing unit includes a hydraulic pressure supply device configured to generate the hydraulic pressure of the pressurizing medium by operating a hydraulic piston by the electrical signal, a first hydraulic circuit configured to control flows of pressurizing media supplied to a first wheel cylinder and a second wheel cylinder, a second hydraulic circuit configured to control flows of pressurizing media supplied to a third wheel cylinder and a fourth wheel cylinder, and a hydraulic pressure control device configured to control flows of pressurizing media that is supplied from the hydraulic pressure supply device to the first and second hydraulic circuits or returned from the first and second hydraulic circuits to the hydraulic pressure supply device,
the pedal unit and the hydraulic pressure providing unit are disposed to be physically separated from each other on a vehicle body,
the hydraulic pressure supply device includes a first pressure chamber provided at one side of the hydraulic piston, and a second pressure chamber provided at the other side of the hydraulic piston, and
the hydraulic pressure control device includes a connecting flow path connecting the first pressure chamber and the second pressure chamber, and a controlling valve provided on the connecting flow path to control the flow of the pressurizing medium between the first pressure chamber and the second pressure chamber.

2. The electronic brake system of claim 1, wherein the hydraulic pressure providing unit further includes a reservoir in which the pressurizing medium is stored,
the first hydraulic circuit includes a first inlet valve and a second inlet valve respectively provided at inlet sides of the first wheel cylinder and the second wheel cylinder to control the flows of the pressurizing media, and a first outlet valve and a second outlet valve respectively provided at outlet sides of the first wheel cylinder and the second wheel cylinder to control the flows of the pressurizing media discharged to the reservoir, and
the second hydraulic circuit includes a third inlet valve and a fourth inlet valve respectively provided at inlet sides of the third wheel cylinder and the fourth wheel cylinder to control the flows of the pressurizing media, and a third outlet valve and a fourth outlet valve respectively provided at outlet sides of the third wheel cylinder and the fourth wheel cylinder to control the flows of the pressurizing media discharged to the reservoir.

3. The electronic brake system of claim 2, wherein the first to fourth outlet valves are each provided as a normal open type solenoid valve that is normally open and then operated to be closed upon receiving an electrical signal.

4. The electronic brake system of claim 2, wherein the first to fourth outlet valves are each provided as a normal closed type solenoid valve that is normally closed and then operated to be opened upon receiving an electrical signal.

5. The electronic brake system of claim 2, wherein any one of the first and second outlet valves is provided as a normal open type solenoid valve that is normally open and then operated to be closed upon receiving an electrical signal,
the other one of the first and second outlet valves is provided as a normal closed type solenoid valve that is normally closed and then operated to be opened upon receiving an electrical signal,
any one of the third and fourth outlet valves is provided as a normal open type solenoid valve that is normally open and then operated to be closed upon receiving an electrical signal, and
the other one of the third and fourth outlet valves is provided as a normal closed type solenoid valve that is normally closed and then operated to be opened upon receiving an electrical signal.

6. The electronic brake system of claim 2, wherein the pedal simulator includes a simulation piston displaced by the operation of the brake pedal, a simulation chamber whose volume is changed by the displacement of the simulation piston, and an elastic member provided in the simulation chamber, compressed by the displacement of the simulation piston, and configured to provide the pedal feel through an elastic restoring force generated from the compression.

7. The electronic brake system of claim 6, wherein the
the hydraulic pressure control device includes a first hydraulic flow path communicating with the first pressure chamber, a second hydraulic flow path communicating with the second pressure chamber, a third hydraulic flow path to which the first hydraulic flow path and the second hydraulic flow path are joined, a fourth hydraulic flow path branched off from the third hydraulic flow path and connected to the first hydraulic circuit, a fifth hydraulic flow path branched off from the third hydraulic flow path and connected to the second hydraulic circuit, a sixth hydraulic flow path communicating with the first hydraulic circuit, a seventh hydraulic flow path communicating with the second hydraulic flow path, an eighth hydraulic flow path to which the sixth hydraulic flow path and the seventh hydraulic flow path are joined, a ninth hydraulic flow path branched off from the eighth hydraulic flow path and connected to the first pressure chamber, and a tenth hydraulic flow path branched off from the eighth hydraulic flow path and connected to the second pressure chamber, and
the connecting flow path includes the ninth hydraulic flow path and the tenth hydraulic flow path.

8. The electronic brake system of claim 7, wherein the hydraulic pressure control device includes a first valve provided on the first hydraulic flow path to control the flow of the pressurizing medium, a second valve provided on the second hydraulic flow path to control the flow of the pressurizing medium, a third valve provided on the fourth hydraulic flow path to control the flow of the pressurizing medium, a fourth valve provided on the fifth hydraulic flow path to control the flow of the pressurizing medium, a fifth valve provided on the sixth hydraulic flow path to control the flow of the pressurizing medium, a sixth valve provided on the seventh hydraulic flow path to control the flow of the pressurizing medium, a seventh valve provided on the ninth hydraulic flow path to control the flow of the pressurizing medium, and an eighth valve provided on the tenth hydraulic flow path to control the flow of the pressurizing medium, and
the controlling valve includes the seventh valve and the eighth valve.

9. The electronic brake system of claim 8, wherein the first valve is provided as a check valve configured to allow only the flow of the pressurizing medium discharged from the first pressure chamber,
the second valve is provided as a check valve configured to allow only the flow of the pressurizing medium discharged from the second pressure chamber,
the third valve is provided as a check valve configured to allow only the flow of the pressurizing medium from the third hydraulic flow path toward the first hydraulic circuit,
the fourth valve is provided as a check valve configured to allow only the flow of the pressurizing medium from the third hydraulic flow path toward the second hydraulic circuit,
the fifth valve is provided as a check valve configured to allow only the flow of the pressurizing medium discharged from the first hydraulic circuit,
the sixth valve is provided as a check valve configured to allow only the flow of the pressurizing medium discharged from the second hydraulic circuit, and
the seventh valve and the eighth valve are provided as a solenoid valve configured to control the flow of the pressurizing medium in both directions.

10. The electronic brake system of claim 2, wherein the hydraulic pressure providing unit further includes a hydraulic dumper provided between the reservoir and the hydraulic pressure supply device to control the flow of the pressurizing medium, and
the hydraulic dumper includes a first dump flow path connecting the first pressure chamber and the reservoir, a second dump flow path connecting the second pressure chamber and the reservoir, a first dump valve provided on the first dump flow path to control the flow of the pressurizing medium, and a second dump valve provided on the second dump flow path to control the flow of the pressurizing medium.

11. The electronic brake system of claim 10, wherein the reservoir includes a first reservoir chamber connected to the hydraulic dumper, a second reservoir chamber connected to the first hydraulic circuit side, and a third reservoir chamber connected to the second hydraulic circuit side.

12. An electronic brake system comprising:
a pedal unit connected to a brake pedal and operated by a driver's pedal force; and
a hydraulic pressure providing unit configured to generate a hydraulic pressure of a pressurizing medium for braking a vehicle based on an electrical signal output in response to displacement of the brake pedal,
wherein the pedal unit includes a pedal simulator configured to generate a reaction force to a pedal force of the brake pedal and provide a pedal feel to the driver,
the hydraulic pressure providing unit includes a hydraulic pressure supply device configured to generate the hydraulic pressure of the pressurizing medium by operating a hydraulic piston by the electrical signal, a first hydraulic circuit configured to control flows of pressurizing media supplied to a first wheel cylinder and a second wheel cylinder, a second hydraulic circuit configured to control flows of pressurizing media supplied to a third wheel cylinder and a fourth wheel cylinder, a hydraulic pressure control device configured to control flows of pressurizing media that is supplied from the hydraulic pressure supply device to the first and second hydraulic circuits or returned from the first and second hydraulic circuits to the hydraulic pressure supply device, and a hydraulic pressure auxiliary device configured to operate when the hydraulic pressure supply device is inoperable so as to auxiliarily provide the hydraulic pressure of the pressurizing medium to the first and second hydraulic circuits,
wherein the pedal unit and the hydraulic pressure providing unit are disposed to be physically separated from each other on a vehicle body, and
the hydraulic pressure auxiliary device includes a first hydraulic pump and a second hydraulic pump configured to generate the hydraulic pressure of the pressurizing medium, a first auxiliary hydraulic flow path connecting a discharge end of the first hydraulic pump and the first hydraulic circuit, a second auxiliary hydraulic flow path connecting a discharge end of the second hydraulic pump and the second hydraulic circuit.

13. The electronic brake system of claim 12, wherein the hydraulic pressure auxiliary device further includes a first auxiliary discharge flow path connecting downstream sides of the first and second outlet valves and a suction end of the first hydraulic pump, and a second auxiliary discharge flow path connecting downstream sides of the third and fourth outlet valves and a suction end of the second hydraulic pump.

14. The electronic brake system of claim 13, wherein the hydraulic pressure auxiliary device further includes a backup motor configured to operate the first and second hydraulic pumps.

15. The electronic brake system of claim 12, wherein the hydraulic pressure providing unit further includes:
a first electronic control unit configured to control operation of the hydraulic pressure supply device; and
a second electronic control unit configured to control operation of the hydraulic pressure auxiliary device.

16. The electronic brake system of claim 12, wherein the pedal simulator includes a simulation piston displaced by the operation of the brake pedal, a simulation chamber whose volume is changed by the displacement of the simulation piston, and an elastic member provided in the simulation chamber, compressed by the displacement of the simulation piston, and configured to provide the pedal feel through an elastic restoring force generated from the compression.

17. The electronic brake system of claim 12, wherein the hydraulic pressure supply device further includes a first pressure chamber provided at one side of the hydraulic piston, and a second pressure chamber provided at the other side of the hydraulic piston.

18. The electronic brake system of claim 17, wherein the hydraulic pressure providing unit further includes a reservoir in which the pressurizing medium is stored, and a hydraulic dumper provided between the reservoir and the hydraulic pressure supply device to control the flow of the pressurizing medium, and
the hydraulic dumper includes a first dump flow path connecting the first pressure chamber and the reservoir, a second dump flow path connecting the second pressure chamber and the reservoir, a first dump valve provided on the first dump flow path to control the flow of the pressurizing medium, and a second dump valve provided on the second dump flow path to control the flow of the pressurizing medium.

19. The electronic brake system of claim 18, wherein the reservoir includes a first reservoir chamber connected to the hydraulic dumper, a second reservoir chamber connected to the first hydraulic circuit side, and a third reservoir chamber connected to the second hydraulic circuit side.

20. The electronic brake system of claim 1, wherein the hydraulic pressure providing unit includes a first circuit pressure sensor for detecting the hydraulic pressure of the pressurizing medium transmitted to the first hydraulic circuit and a second hydraulic pressure sensor for detecting the hydraulic pressure of the pressurizing medium transmitted to the second hydraulic circuit.
